(19) United States
(12) Patent Application Publication
(10) Pub. No.: US 2004/0087363 A1
(43) Pub. Date: May 6, 2004

(54) Digital video game strategy guide

(76) Inventor: Timothy F. Bogenn, Greenville, NC (US)

Correspondence Address: OLIVE & OLIVE, P.A., 500 MEMORIAL STREET, PO BOX 2049, DURHAM, NC, 27702, US

(21) Appl. No.: 10/287,983

(22) Filed: Nov. 5, 2002

(51) Int. Cl. A63F 13/00

(52) U.S. Cl. 463/29

(57) ABSTRACT

A digital video game strategy guide for learning to play a selected video game. The strategy guide includes a completed video game result, helpful comments with respect to strategy for playing the video game, and a menu for accessing different sections of the digital video game strategy guide.

### BACKGROUND OF INVENTION

The invention relates to video game strategy guides. In particular, the invention relates to a system for providing a video game user strategy and to a digital video game strategy guide.

As computers and the software running on them have become more powerful and more complex, video games designed to run on them also have become increasingly more difficult and complex to play. The most difficult games have a series of play levels with each level being successively more difficult or presenting new and varied challenges. The video games typically involve a character that must be moved in an effectively 3-D manner using a joystick or computer keyboard input. Many games require solving puzzles or riddles and navigating mazes, as well as accomplishing certain other tasks. The methods of performing these tasks by the game user are not always evident from the direct information given in the game or from the written instructions supplied with the game. The game user often is expected to determine how to accomplish a task based on either direct or indirect clues provided during the game, or in some cases by trial and error while playing the game. The problem for the game user in playing this type of video game, however, is that if a single solution, navigation, or other task in the game is not discovered or not accomplished, this failure may prevent the game user from continuing past a given point in the game. Typically, video games give no help with such situations.

Because this problem seems to face most video game users, a substantial market has grown around video game strategy guidebooks and manuals, which provide such help. Guidebooks and manuals provide explanations or solutions to puzzles or riddles, the whereabouts of certain items to be discovered, and the like. Guidebooks rarely give a specific strategy or describe precisely how to move about in the game, but rather provide generalities. The game user still must use trial and error to figure out exactly how the explanation in the guidebook translates to playing the game.

Videotape strategy guides have been attempted in the market in the past but have failed commercially for a number of reasons. These reasons for failure include the difficulty in accessing the information on the videotape guides, the need for a videotape player in addition to the computer or video game console, and the difficulty of pausing the videotape while still viewing the picture clearly. Some on-line tutorials are available for select video games, but present their own problems.

A problem with all of these approaches, including manuals, videotapes, and on-line tutorials, is that they fail to give the video game user the actual feel of how the game solutions, navigations, and other tasks are played in real time. This real-time play is important because small changes in position and movement of the game character on the video screen can make major differences to the result achieved during play. Current strategy guides lack this important component. Therefore, there is a need to overcome the problems and limitations of the prior art in providing video game strategy to video game users.

### SUMMARY OF INVENTION

The present invention comprises a system for providing a video game user strategy for a selected video game. The selected video game is playable on a computer, a digital video player, or other video game console, as is the digital video game strategy guide of the invention. The digital video game strategy guide comprises a completed video game result, an access menu for accessing selected points in the completed video game result, and an associated audio strategy commentary portion. The method of the present invention provides a digital video game strategy guide for users of video games, such as a selected video game playable on a computer, on a video game console, or on a digital video disk player, or the like, and comprises recording a completed video game result, recording an audio strategy commentary portion in synchronous relationship to the recorded result, and providing an access menu to the completed video game result. The digital video game strategy guide of the invention comprises a recording of a selected completed video game result, an audio strategy commentary, and an access menu for accessing selected points in the completed video game result.

It is an object of the present invention to provide a digital video game strategy guide and method of making such a guide that overcome the problems and limitations described above and provide improved assistance in playing video games.

It is another object of the present invention to provide a digital video game strategy guide that provides a real-time view of a successfully played video game and corresponding advice to a potential video game user as to how to play such a game successfully.

It is yet another object of the invention to provide a video game console that provides the game user access to the various levels in the digital video game strategy guide corresponding to the play levels in the video game.

The foregoing objects, as well as others, are achieved based on the system, method, and product of the invention herein described.

### BRIEF DESCRIPTION OF DRAWINGS

In order that the invention will be more clearly understood it will be disclosed in greater detail with reference to the accompanying drawings, in which:

FIG. 1 is a flow chart of the production of the digital video game strategy guide of the present invention;

FIG. 2 is a flow chart of the production of the digital video game strategy guide of the present invention illustrating the use of readily available equipment to create a DVD version of the digital video game strategy guide; and

FIG. 3 is a flow chart of the relationship of the present invention strategy guide to video game user play.

### DETAILED DESCRIPTION

The present invention comprises a system for providing a video game user strategy for a selected video game, a method for providing strategy to a user of such a selected video game, and a digital video game strategy guide for learning to play such a selected video game. Current video game manuals, videotapes, and on-line materials do not provide such a system, method or strategy guide that enable easy access to different levels of play or other selected points. In the strategy guides of the present invention, the combination of viewing the video game being played while listening to a summary commentary solves problems not addressed by the prior art strategy guides. It is also significant that the strategy guide of the invention is operable on the same device as that on which the selected video game is operated. Video games presently are operated on any of a variety of devices, including computers, digital video disk players, and other known devices commonly referred to as video game consoles (such as those presently sold under the brand names NINTENDO and PLAYSTATION, for example). The present invention contemplates operation of the video game strategy guide on any of these devices, and on digital readers that may be known or developed in the future. For convenience, all such devices are referred to hereafter as video game consoles.

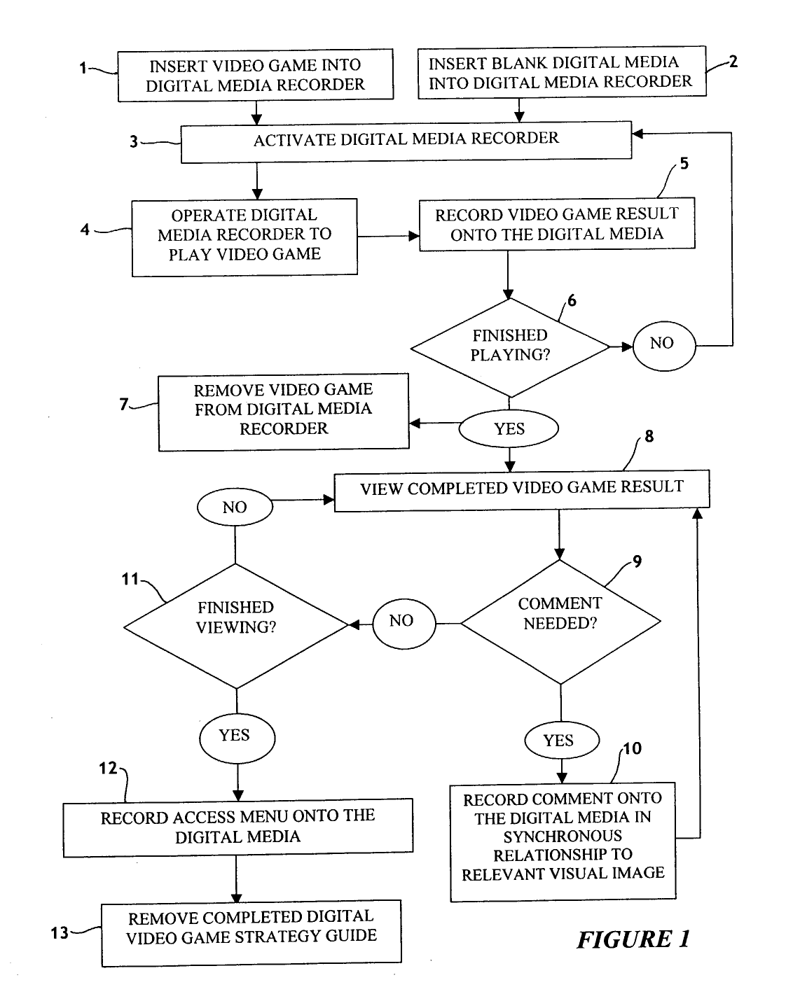

Referring now to the flow charts, FIG. 1 is a flow chart representation of the process of making the present invention comprising making a digital video game strategy guide for a given video game. In order to produce the digital video game strategy guide of the invention, at steps 1 and 2, a digital video game strategy guide producer inserts a selected video game and blank digital media such as a DVD, into a digital media recorder and, at step 3, activates the digital media recorder. As used herein, “digital” media include, for example, DVDs, CD-ROMs, and cartridges containing flash RAM (random access memory) and/or ROM (read only memory). It is anticipated that in the future, other digital media will be developed for video games. Consequently, such digital media also are considered as within the scope of the invention. In a preferred embodiment, the digital media recorder is a digital video disk (DVD) recorder. Since current games are played using DVDs, the resultant digital video game strategy guide likewise can be played on most current dedicated video game consoles, as well as on computers or digital media players.

At steps 4 and 5, the producer operates the digital media recorder and plays the video game, thereby creating a recording of what transpires during the game, hereinafter referred to as the video game result, on the digital media. It is contemplated that the video game result will be substantially identical to the video game display that appears on the screen while the producer is playing the game. Alternatively, the video game result could consist of independent screen shots at selected intervals of the play rather than a continuous record of the play, but this is not preferred. Ordinarily, the video game result will contain only visual images but where audio components are important to understanding the play or are desired for some other reason, they may be included. It is not necessary that the color of the video game result be identical to that of the video game display, although ordinarily, identical colors are preferred so that the ultimate digital video game strategy guide will look substantially identical to the relevant sections of the video game itself, in all respects.

When the video game has been completely played from start to finish (or a desired portion thereof has been played), and the video game result has been recorded, then as shown at steps 6 and 7, the video game may be removed from the digital media recorder. The producer, at step 8, views the completed video game result. By completed video game result is herein meant a video game result that depicts the video game (or a selected portion thereof) played through completely from the start to the end of the game (or the selected portion thereof) in a manner that completes all the solution, navigation, and other tasks required for completion of the video game (or the selected portion thereof). Ordinarily the entire video game will be played. An abbreviated digital video game strategy guide may be produced by playing only a portion of the video game (for example, only the more difficult sections of the video game) and thus creating a completed video game result that incorporates only a subset of completed game tasks, but this is not preferred.

After the completed video game result has been recorded on digital media by the digital media recorder, the producer views the completed video game result and preferably adds comments to it as shown at steps 9 and 10. It is preferred that the comments be voice comments, but text comments could be added instead of, or in addition to, the voice comments. The comments are explanations of the strategy that a video game user needs to implement for successful completion of the video game, presented in synchronous relationship to the depiction of game play contained in the completed video game result. For example, if there is a point in the video game result where the producer was presented with a choice of turning left or right in the game, and turned right, the voice commentary recorded on the digital media at that point in the video game result might state, “When you come to the T-junction, turn right.” The voice may be an observer's voice, the voice of a character on the video game, or an artificial (computer-generated) voice. While comments can be omitted altogether, since visual images alone are sufficient in most cases to depict what the user should do, comments are preferred. In the preferred embodiment, comments are added in synchronous relationship to visual images that appear on the completed video game result, but comments could instead, or in addition, be added in synchronous relationship to sounds that appear on the completed video game result.

After the completed video game result has been viewed and comments, if desired, have been entered, the producer adds to the digital media an access menu for accessing selected points in the completed video game result, as shown in steps 11 and 12. The access menu is created using means known in the art or hereafter developed, for example, hyperlinks from a menu to selected portions of the completed video game result. Although the term “menu” is used for convenience and the access menu in a preferred embodiment is in the form of a screen-displayed menu, this is not intended to be limiting, as those skilled in the art will recognize alternate modes of providing the user with a choice of access points, each of which is intended to come within the scope of this invention.

In a preferred embodiment in which the video game has multiple play levels, the selected points will be the beginning of each of these play levels. The access menu also, or alternatively, can provide access at other selected points on the completed video game result, for example, based on selected geographic locations or types of tasks to be performed. Thus, if a mountain peak is a feature of the video game and tasks are to be performed there, the access menu may be provided with an icon depicting the mountain peak. The mountain peak icon then will be linked to a point on the digital video game strategy guide that shows tasks to be accomplished at the selected geographic location, so that a user can observe the digital video strategy guide as it depicts those tasks and teaches how to resolve them. The access menu may instead, or in addition, be based upon tasks to be performed in the game. In that case, an access menu item might be “swimming”, with a link to a point on the digital video strategy guide in which successful strategies for swimming can be observed. It will be readily appreciated that sub-menus and more sophisticated selections of menu items will be appropriately used when it is desired to present the game user with additional choices, and all such access menus are within the scope of this invention. For example, if multiple different tasks are to be performed at the mountain peak referred to earlier, the mountain peak icon may link to a submenu, or be displayed initially with a submenu, describing each of the different tasks so that a user can select and observe the section of immediate interest.

Rather than being recorded following insertion of comments as shown in FIG. 1, the access menu can be recorded before comments are added, since ordinarily it is keyed to the visual images being displayed. Once the desired comments and access menu have been added to the completed video game result, the master digital video strategy guide is complete and can be copied onto appropriate digital media for distribution and use by game users, or can itself be used as a digital video strategy guide.

Thus, as set forth above, the three parts comprising the preferred embodiment of the digital video game strategy guide of the invention as shown in FIG. 1 are the completed video game result, the comments, and the access menu.

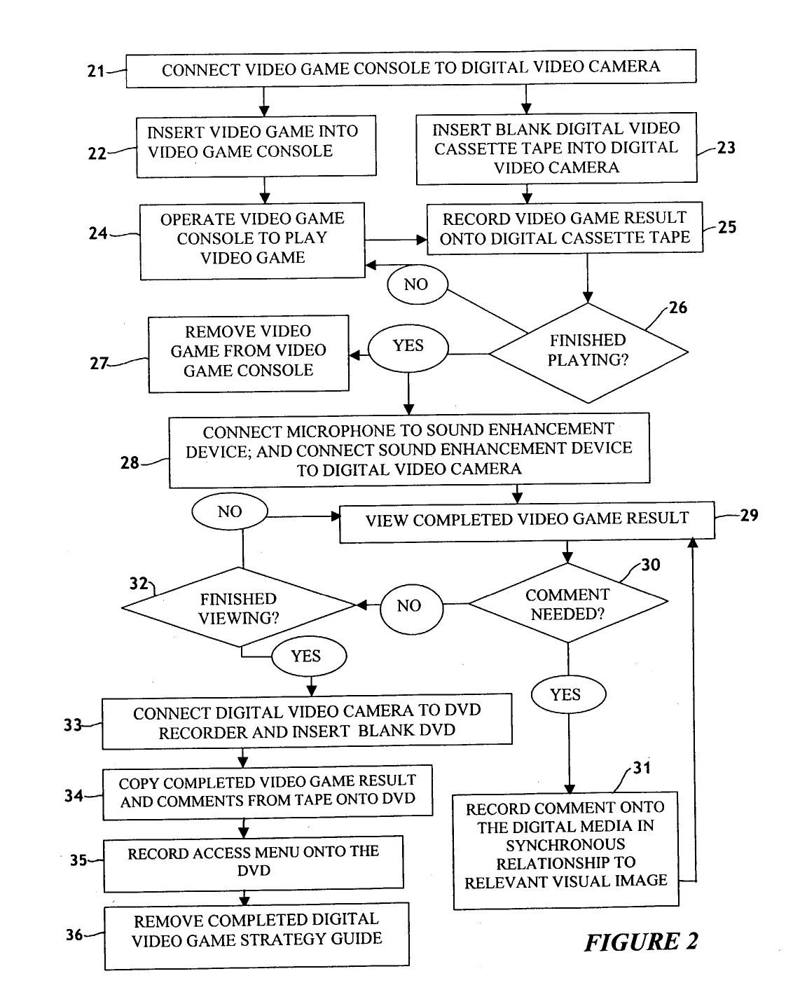

Although FIG. 1 depicts using a single device, as are known in the art, capable of simultaneously playing the video game and recording the play results onto the blank digital media, it is within the scope of the invention to use separate devices for this purpose. When the digital media for the digital video game strategy guide is to be a DVD, for example, then in order to use readily available equipment to create the digital video game strategy guide, steps 1-10 shown in FIG. 1 are preferably performed using a digital video cassette recorder, and the video game results as well as the comments are recorded on digital video cassette tape as shown in FIG. 2. In the FIG. 2 embodiment, at step 21, the producer connects a typical dedicated video game console (for example, a GAMECUBE or PLAYSTATION brand video game console) to a digital video camera (for example, a SONY brand digital video camera). Standard connection cables known in the art are used to make this connection, typically an S-video cable and two audio AV cables to give both picture and stereo sound. At steps 22 and 23, the producer inserts a selected video game into the video game console, and inserts a blank digital video cassette tape into the digital video camera. At steps 24 and 25, the producer plays the game and records it onto the tape, preferably using 12-bit audio mode so that another track, or layer, of sound can be added later. As shown at steps 26 and 27, when the video game has been completely played from start to finish (or a desired portion thereof has been played), and the video game result has been recorded, the video game may be removed from the digital media recorder.

The producer, at step 28, connects a sound input device to a microphone input jack contained on the digital video camera. For example, a SURE brand, model SM58 vocal microphone can be used, preferably connected utilizing an intermediate sound manipulation device such as a MIDIVERB brand system. In that case, the SURE SM58 microphone is connected by a standard cable to an input jack in the MIDIVERB system, and a second standard cable is connected from the output jack of the MIDIVERB system to the camera's microphone input jack using a standard adaptor to reduce the ¼″ plug size of a standard cable to the ⅛″ size required by the camera's microphone input jack. At steps 29-31, the producer views the completed video game result, determines whether a comment is needed, and records appropriate vocal comments onto the second audio track, or layer, of the digital video cassette tape, in synchronous relationship to the depiction of game play contained in the completed video game result.

At steps 32-33, the producer determines whether all desired comments have been added, and, if so, connects the digital video camera to a DVD recorder and inserts a blank DVD into the DVD recorder. One DVD recorder suited for this purpose is the PHILIPS brand, model DVDR 985 DVD recorder. Standard connection cables known in the art are used to connect the digital video camera to the DVD recorder, using the S-video and AV output jacks of the camera and connecting them to the related input jacks of the DVD recorder. At step 34, the producer copies the completed video game result with comments from the digital video cassette tape onto the DVD. At step 35, an access menu is created. When a PHILIPS DVDR 985 DVD recorder is used, then the access menu is created and recorded onto the DVD of the digital video game strategy guide using the menu creation system provided with that DVD recorder.

At step 36, the producer removes the DVD from the DVD recorder. This now is a master digital video game strategy guide, containing the completed video game result, voice comments in synchronous relationship to the depiction of game play contained in the completed video game result, and the access menu. The digital video game strategy guide can be used immediately, or preferably is used as a master from which additional copies are burned onto DVDs for distribution and sale.

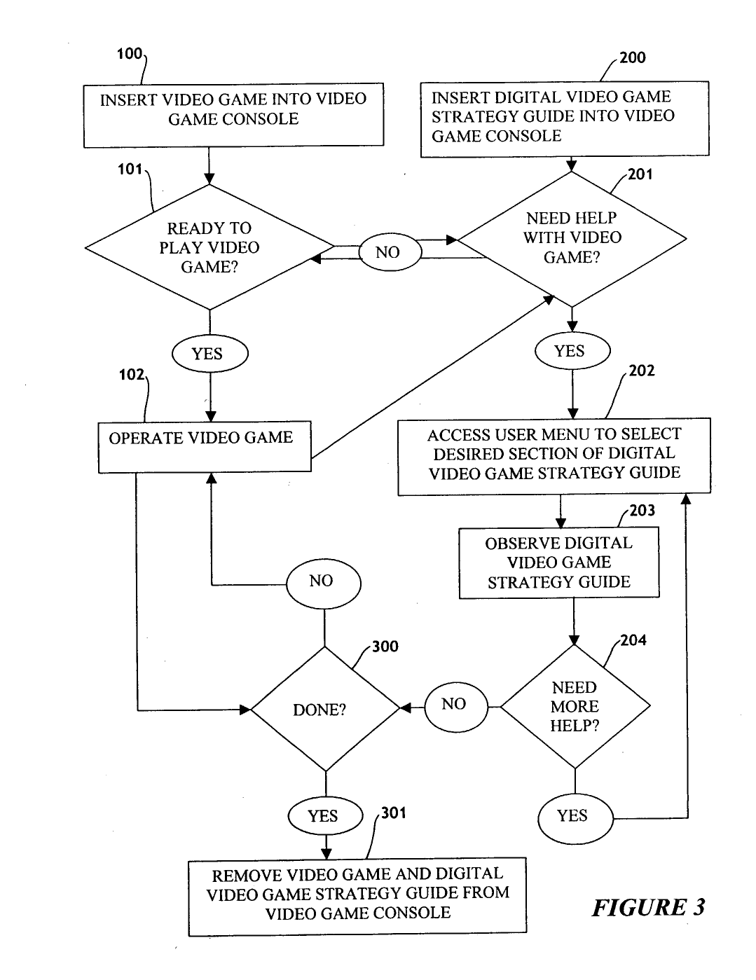

FIG. 3 is a flow chart representation of a game user using the digital video game strategy guide of the present invention. As shown in steps 100 and 200, the game user inserts the video game and the digital video game strategy guide into a video game console. It should be noted that at present, many video game consoles have room only for one DVD or other digital media, although some computers have the capability to contain and play two DVDs or a CD-ROM and a DVD, simultaneously. When a game user is using a conventional single-drive video game console, then the video game and digital video game strategy guide can be interchangeably placed in the slot for that drive, depending on which is to be used. Alternatively, the video game can be played on a first video game console and the digital video game strategy guide can be displayed on a second video game console or on another device designed to permit viewing digital media of the type on which the digital video game strategy guide is recorded.

As shown in steps 101, 201 and 202, if the game user wants help with the video game, the game user accesses the access menu of the digital video game strategy guide and selects from it the selected portion (such as the play level, geographic section, or task) of the digital video game strategy guide that the game user wishes to observe. As shown in step 203, the game user then observes the selected section of the digital video game strategy guide. It is preferred that when the game user has finished viewing the selected portion, the game user will be presented with a choice, as shown at step 204, to either continue observing the digital video game strategy guide, or to stop viewing the digital video game strategy guide in order to play the video game based on what was learned from it. However, alternatively the digital video game strategy guide can simply continue playing until halted.

After the desired amount of the digital video game strategy guide has been viewed, the game user then plays (if desired) the video game, as shown at step 102. At any time help is desired, the game user can again use the access menu to observe the digital video game strategy guide, as shown in steps 102 and 201-203. Preferably, the video game will be paused while the digital video game strategy guide is observed, so that play resumes at the point where the game user encountered a problem or question that occasioned resort to the digital video game strategy guide.

When all desired portions of the video game have been played and all desired portions of the digital video game strategy guide have been observed, then as shown at steps 300 and 301, the video game and digital video game strategy guide may be removed from the video game console or, if the video game console is a computer, the game user simply exits from the video game and digital video game strategy guide.

Accordingly, a digital video game strategy guide of the present invention has been disclosed which solves the problems of the prior art. The various alternatives disclosed and described herein are the best mode contemplated by the inventor for carrying out the invention at the time of filing this application and are provided by way of example and not as a limitation. It should be understood that various choices, modifications and adaptations thereof will occur to those persons of ordinary skill in the art to which it pertains and are deemed to lie within the scope of the present invention as set forth in the disclosure of the invention and the following claims. Accordingly, the new and useful constructions, and reasonable equivalents thereof obvious to those skilled in the art, are set forth in the appended claims.

What is claimed is:

1. A system for providing a video game user strategy for a selected digital video game, comprising:
(a) a digital video game strategy guide playable on a video game console, said digital video game strategy guide having recorded thereon a completed video game result of the selected video game and an access menu for accessing a desired portion of the completed video game result; and
(b) a video game console capable of playing the digital video game strategy guide.

2. A system according to claim 1, wherein the digital video game strategy guide is on a digital video disk.

3. A system according to claim 1, wherein the video game has a plurality of play levels and the digital video strategy guide contains a menu providing access to a desired one of the plurality of play levels.

4. A system according to claim 1, wherein the video game has a plurality of geographic locations and the digital video strategy guide contains a menu providing access to a desired one of the plurality of geographic locations.

5. A system according to claim 1, wherein the video game has a plurality of tasks and the digital video strategy guide contains a menu providing access to a desired one of the plurality of tasks.

6. A system according to claim 1, wherein the digital video game strategy guide also has comments recorded thereon.

7. A system according to claim 6, wherein at least one comment is a voice comment.

8. A system according to claim 6, wherein at least one comment is a text comment.

9. A method of providing strategy to a user of a selected video game playable on a video game console comprising:
(a) recording a completed video game result of the selected video game onto digital media using a digital media recorder; and
(b) providing an access menu to allow the user to access a selected portion of the completed video game result.

10. A method according to claim 9, wherein the digital media is a digital video disk.

11. A method according to claim 9, wherein the method further comprises recording comments in a synchronous relationship to the completed video game result.

12. A digital video game strategy guide for learning to play a selected video game comprising:
(a) a completed video game result of the selected video game;
(b) an access menu for accessing a desired portion of the completed video game result; and
(c) wherein the digital video game strategy guide is playable on a video game console that also is capable of playing the selected digital video game.

13. A digital video game strategy guide according to claim 12, wherein the digital video game strategy guide is on a digital video disk.

14. A digital video game strategy guide according to claim 12, wherein the digital video game strategy guide further comprises comments recorded in a synchronous relationship to the completed video game result.
